(19) United States
(12) Patent Application Publication
(10) Pub. No.: US 2009/0210722 A1
(43) Pub. Date: Aug. 20, 2009

(54) System for and method of locking and unlocking a secret using a fingerprint

(76) Inventor: Anthony P. Russo, New York, NY (US)

Correspondence Address: HAVERSTOCK & OWENS LLP, 162 N WOLFE ROAD, SUNNYVALE, CA, 94086, US

(21) Appl. No.: 12/315,141

(22) Filed: Nov. 26, 2008

Related U.S. Application Data
(60) Provisional application No. 61/004,670, filed on Nov. 28, 2007.

(51) Int. Cl. H04L 9/32; H04L 9/28

(52) U.S. Cl. 713/189; 380/28; 380/29

(57) ABSTRACT

The present invention provides a way to lock a secret in a portable package. The package contains the key needed to unlock it. The key is dispersed throughout the encrypted data so that an attacker has no way to feasibly recover it. The package also contains information that uniquely identifies users who are authorized to unlock the secret. In a preferred embodiment, the information is fingerprint image data, such as fingerprint templates. The locked secret thus has several levels of security, requiring information needed to recover and assemble the key, information about the decryption algorithm that uses the key to unlock the secret, and biometric information needed to grant a user permission to unlock the secret.

### RELATED APPLICATION

This application claims priority under 35 U.S.C. § 119(e) of the co-pending U.S. provisional patent application Ser. No. 61/004,670, filed Nov. 28, 2007, and titled “Method for Encrypting a Secret and Unlocking it with a Fingerprint Match, System and Method to Improve Security and Authentication Process on a Device that Uses Windows Mobile OS, and Protective Encapsulation Method for a Fingerprint Sensor,” which is hereby incorporated by reference in its entirety.

### FIELD OF THE INVENTION

This invention is related to data encryption. More specifically, this invention is related to protecting secret information using biometric images.

### BACKGROUND OF THE INVENTION

Today's biometric systems can be used to grant only authorized users access to computers and digital media, but they are not as secure as they seem. This is because encryption methods require a long, reproducible key to encrypt and decrypt data, whether it be to logon to servers or decrypt a file or unlock a SIM card with a PIN. Typical non-biometric systems prompt the user for a password or passphrase each time decryption is required. The password or passphrase can itself be used as the encryption key, or it can be used instead to unlock a longer, more secure key.

The use of a passphrase in either of these ways significantly reduces the security of the system because, for the user to remember the passphrase, the passphrase would either not be very random or not have nearly as many bits as a strong encryption key. Despite the reduced security, many such systems are deployed today with acceptable results. However, entering the passphrase is cumbersome for the user.

Existing biometric systems aim to eliminate this burden by using only a fingerprint to gain access to encrypted data and services. This is typically done by storing the secret data with a master encryption key, and then hiding the master key someplace where it is unlikely to be found by attackers. When the biometric data is successfully matched, the key is retrieved and the data is decrypted for use by downstream systems. The problem with this method is in where the master key is hidden. If it is hidden in the code or on the file system, it may be discovered by an attacker given enough time and effort. It is important to point out that the master key will allow access to all the secrets stored on the biometric system, which is yet another security drawback. Another drawback is that the individual secrets cannot be transported to another computing platform without also taking the master key with them. By taking the master key, it is exposed and therefore vulnerable to attack.

One alternative is to use a secure element such as a smartcard or SIM to store the master key. However, these devices all require a PIN to retrieve the master key. If the user is required to enter a PIN every time access is required, the convenience of biometrics is diminished significantly. In many cases, a secure element is not even available on the computing platform, thereby limiting the use of this alternative. Storing secrets on a remote server is yet another option. But it adds complexity, requires more bandwidth, and is not usable in an off-line state.

Prior art exists in encryption and steganography. Some prior art combines biometric data with encryption. U.S. Pat. No. 5,712,912 to Tomko et al. describes a way to use the biometric itself as the encryption key, but that approach does not generate with 100% certainty a repeatable key for every decryption attempt. U.S. Pat. No. 5,495,533 to Linehan et al. requires a key server and is not standalone. Most systems that employ steganography try to hide the secret information in an image or other medium such that the existence of the secret data is not readily detectable, such as with digital watermarking. Other systems rely on a database to unlock the secret or obtain the key. For example, U.S. Pat. No. 7,269,277 to Davida et al. describes using a central database of user indicies to map repeatable keys to users' biometric data. Still others, such as U.S. Pat. No. 6,041,122 to Graunke et al., teach how to derive a repeatable cryptographic key from other phenomena such as timing.

### SUMMARY OF THE INVENTION

In a first aspect of the present invention, a method of formatting ciphertext includes encrypting clear data with a key to thereby produce ciphertext, embedding blocks of key data corresponding to the key at multiple predetermined locations within the ciphertext, and associating biometric information with the ciphertext. The biometric information corresponds to one or more users authorized to decrypt the ciphertext.

The biometric information is associated with the ciphertext by appending one to the other. Alternatively, the biometric information is associated with the ciphertext by appending an identifier of the biometric information to the ciphertext. As one example, the identifier is an address of the biometric information.

In one embodiment, the biometric information is encrypted using the key before the biometric information is associated with the ciphertext. Preferably, the method also includes encrypting the key to generate the key data.

In one embodiment, the biometric information includes one or more hashes of biometric templates. Preferably, the biometric templates are templates of fingerprint images. Alternatively, the biometric templates are templates of palm images, retinal scans, or any other unique physical characteristic of a user.

In one embodiment, each of the one or more hashes is generated using MD-5, Secure Hash Algorithm-1, or a checksum. The key is generated using Data Encryption Standard, Advanced Encryption Standard, or Blowfish. When a length of ciphertext is less than a predetermined threshold value, pad bits are appended to the ciphertext to ensure that it has an adequate length. This length should be large enough to ensure that the key is adequately hidden within the ciphertext.

Blocks containing the segmented key are able to be different sizes, such as any multiple of one byte long or even a single bit long. The block sizes do not have to be the same, but can have different values.

In one embodiment, the method also includes appending to the ciphertext an authentication code, such as a Message Authentication Code (MAC). The MAC is a cryptographic hashing algorithm such as Universal Hashing Message Authentication Code (UMAC), Hash Message Authentication Code (HMAC), or Poly 1305-AES.

In one embodiment, the predetermined locations of the blocks of key data depend on an identity of the key. For example, for one key, the blocks of key data are distributed at a first set of locations. For another key, the blocks are distributed at a second set of locations, different from the first.

In one embodiment, the method also includes encrypting one or more biometric templates associated with users authorized to access ciphertext on a file system. The biometric templates are encrypted; alternatively, the biometric templates are plain text. Whether encrypted or plain text, the biometric templates are part of a database or file that contains the ciphertext. In an alternative embodiment, the biometric templates are part of a database or file different from the one that contains the ciphertext.

In one alternative embodiment, an encrypted version of the one or more biometric templates is appended to the ciphertext. In another alternative embodiment, a plain text version of the one or more biometric templates is appended to the ciphertext.

In a second aspect of the present invention, a method of recovering plain text from ciphertext includes successfully matching first biometric information to second biometric information, combining segments of key data embedded throughout the ciphertext to thereby retrieve a decryption key, and using the decryption key to decrypt the ciphertext to thereby recover the plain text. The second biometric information is associated with a user authorized to recover the plain text. Preferably, the first biometric information and the second biometric information are both hashes of biometric templates, such as templates of fingerprint images. Segments are combined by appending them and filtering the appended segments to retrieve the encryption key. As one example, filtering includes decrypting the appended segments ro recover the original key.

In one embodiment, the method also includes comparing a characteristic of the recovered plain text with a corresponding characteristic stored for the recovered plain text to thereby ensure that the plain text has not been tampered with. The unique characteristic is generated by performing a hashing algorithm on the recovered ciphertext.

In a third aspect of the present invention, a data storage system includes a plurality of data blocks. Each data block includes ciphertext and template information. The ciphertext contains segmented key data derived from a key used to encrypt it embedded throughout. The template information identifies one or more users authorized to decrypt the ciphertext to recover corresponding plain text. In one embodiment, the template information is appended to the ciphertext.

Preferably, the key data for the plurality of data blocks are different from one another. The template information for each of the data blocks is a fingerprint template.

The data storage system also includes a computer-readable medium containing computer-executable instructions for performing a method. The method includes encrypting plain text to generate ciphertext, generating key data from a key, embedding segments of the key data at predetermined locations within ciphertext, and associating first biometric information with the ciphertext containing the embedded segments of the key data.

In another embodiment, the method also includes steps for recovering the plain text: successfully matching second biometric information with the first biometric information, retrieving the embedded key data from the ciphertext, recovering the key from the key data, and using the key to decrypt the ciphertext to thereby recover the plain text. The key is recovered from the key data by combining segments of the key data and then decrypting the key data. The method also includes verifying that the ciphertext has not been tampered with.

### BRIEF DESCRIPTION OF THE DRAWINGS

FIG. 1 is a block diagram of a module containing ciphertext, a key embedded in the ciphertext, and biometric information corresponding to a user authorized to decrypt the ciphertext, in accordance with the present invention.

FIG. 2 shows the steps of a method of recovering plain text from ciphertext using biometric information, in accordance with the present invention.

FIG. 3 is a block diagram of a system for both locking and unlocking a secret with a biometric match in accordance with one embodiment of the present invention.

FIG. 4 illustrates locking a secret in accordance with the present invention.

FIG. 5 illustrates unlocking a secret in accordance with the present invention.

FIGS. 6A-C show key segments embedded within ciphertext at regularly spaced locations, increasingly spaced locations, and randomly spaced locations, respectively, in accordance with different embodiments of the present invention.

FIG. 7 shows ciphertext with biometric template addresses appended to it, in accordance with the present invention.

FIG. 8 shows a database system containing multiple locked secrets in accordance with the present invention.

### DETAILED DESCRIPTION OF THE INVENTION

The present invention provides a decentralized way to store secret data securely such that there is no master key, and such that only a biometric match can unlock the secret. Unlike steganographic systems, embodiments of the present invention do not need to hide the fact that a key is contained in the encrypted data. This knowledge is of little value to an attacker. In one embodiment, secrets are protected a) by using a different key for each secret, b) by hiding the key within the encrypted secret itself, and c) by appending to the encrypted secret a list of biometric templates that corresponds to users authorized to unlock it.

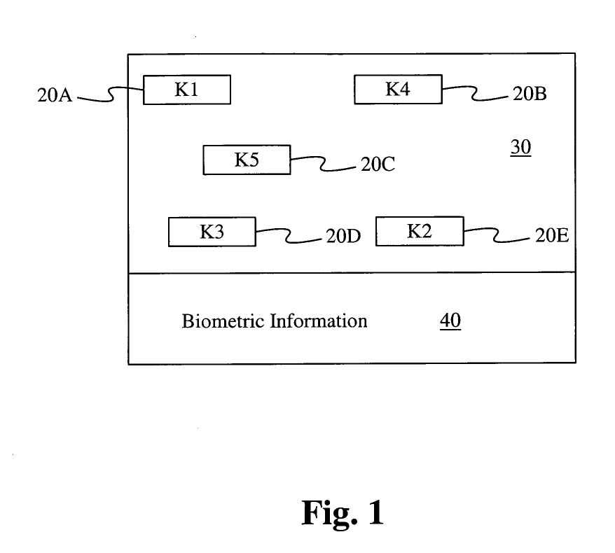

FIG. 1 shows, in part, a data module containing plain text after it has been encrypted with an encryption key to produce ciphertext. The data module 10 is used to explain embodiments of the present invention. Throughout the discussion, the terms “plain text” and “clear text” refer to text, executable code, data containing control and formatting codes, and any other information that can be displayed, executed, processed, or otherwise used on a computing platform. The terms “secret,” “secret data,” “encrypted data,” and “ciphertext” are used interchangeably.

As shown in FIG. 1, the data module 10 includes ciphertext 30 that has embedded within it segments or portions of a key 20A-E that are concatenated as K1+K2+K3+K4, in that order, to form an encryption key 20. Dividing a key into segments or component parts and distributing the segments at predetermined locations within the ciphertext provide several advantages: Because the segments are contained in the data itself, the data and the information needed to decrypt it are self-contained-no separate structure is needed to store the encryption key. And because the key is distributed throughout the ciphertext at locations and sequences unknown to an attacker, the attacker cannot easily recover the key, even if he knew where some of the segments are located. As an added level of security, in some embodiments of the invention, the key itself is not embedded in the ciphertext; instead, “key data,” which identifies the key, is segmented and stored within the ciphertext.

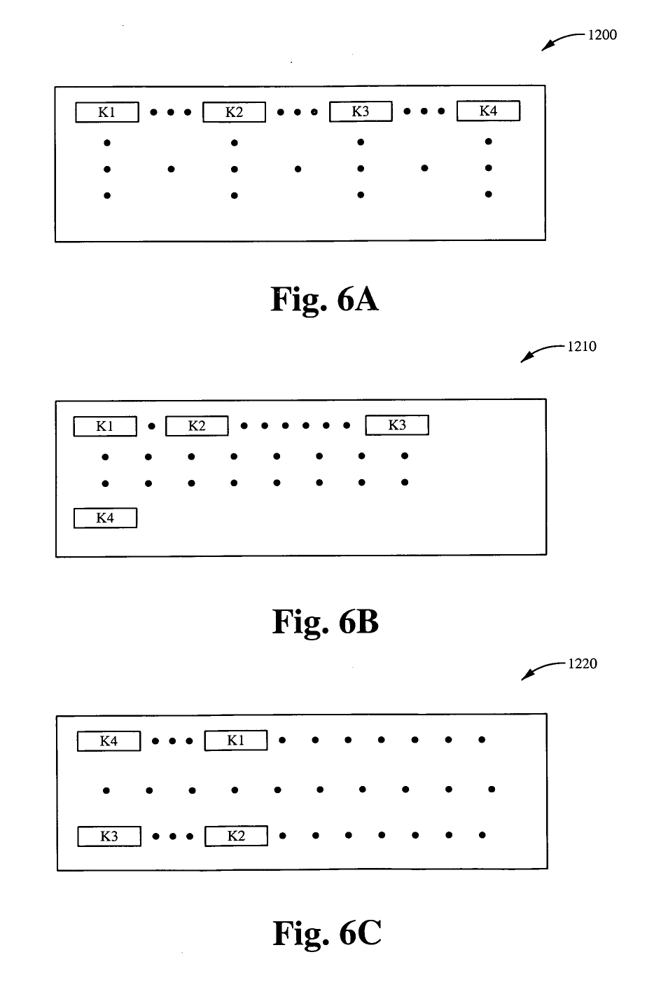

In one embodiment, key data is an encrypted version of the key. Thus, even if the key data is recovered, it too must be decrypted to recover the encryption key. If the key is not encrypted, and the key data is the key itself. As illustrated in FIGS. 6A-C, and described below, key data is able to be embedded within the ciphertext in many different ways.

The data module 10 also includes biometric information that corresponds to users authorized to decrypt the ciphertext 30 to recover the plain text. Preferably, the data module 10 includes all the information needed to recover the plain text from the ciphertext. Thus, the ciphertext is packaged with information that identifies who is allowed to decrypt it. Again, the ciphertext and the information used to decrypt it are self contained.

A system used to generate the data module 10 in accordance with the present invention uses one or more algorithms to 1) generate an encryption key, 2) generate key data corresponding to the encryption key, 3) encrypt plain text to produce the ciphertext, 4) segment the key data and embed it at predetermined locations within the ciphertext, and 5) associate biometric information to the ciphertext, thereby granting certain users authorization to access the ciphertext.

The same or different system used to recover plain text from the data module 10 first uses one or more algorithms to determine whether a user is authorized to recover the plain text from the cipher text. If the user is authorized, the algorithms are used to 1) retrieve the key data segments from the predetermined locations in the ciphertext, 2) combine the recovered segments to produce key data, 3) recover the (combined or composite) key from the key data, and 4) use the key to decrypt the ciphertext to recover the plain text. As described below, when the key is encrypted to generate key data, the key data is later decrypted to recover the key.

In one embodiment, the plain text corresponds to an individual file on a file system. Thus, each file on the file system has its own key data, embedding structure (e.g., sequence and locations of stored key data segments), and list of authorized users. In other embodiments, the plain text is a folder containing multiple files, a directory of files, another file system or data structure, or any combination of these.

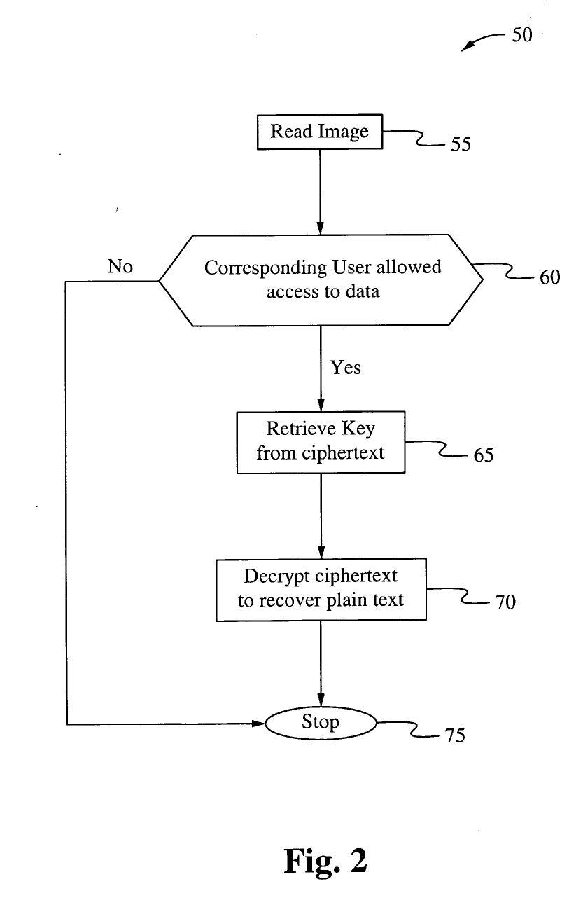

FIG. 2 shows high-level steps 50 of a process for recovering plain text from ciphertext in accordance with the present invention. In the step 55, the process reads a fingerprint image. In the step 60, the process determines whether the fingerprint image corresponds to a user authorized to decrypt the ciphertext. In one embodiment, the fingerprint image is translated to a template and compared with stored templates corresponding to fingerprints of authorized users. If the user is not authorized to decrypt the ciphertext, the process continues to the step 75, where it ends. If the user is authorized, the process continues to the step 65, where a decryption key is recovered from the ciphertext. In the step 70, the process uses the decryption key to decrypt the ciphertext to recover the plain text. The process then ends in the step 75.

In one embodiment, during an enrollment step, the system learns which users are to be given access to specific files. In this step, biometric information gathered from users are associated with certain files. For example, when a user is granted access to a particular file, one or more of his fingerprint images are associated with that file, such as by attaching a template of his fingerprint image or a hash of this template to ciphertext generated from the file. Multiple users are granted access to a file by attaching or otherwise associating fingerprint templates or hashes of fingerprint templates to the ciphertext.

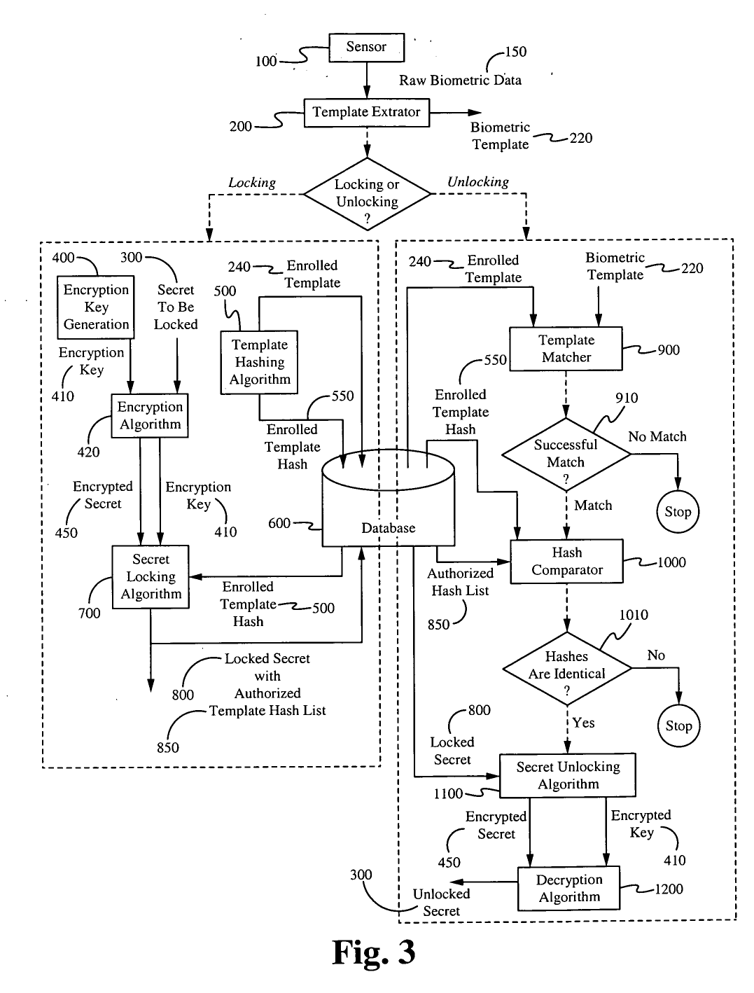

FIG. 3 shows steps of a process and corresponding system components for enrolling users to decrypt ciphertext and decrypting ciphertext in accordance with the present invention. The components include a sensor 100, a template extractor 200, an encryption key generation algorithm 400, an encryption algorithm 420, a secret locking algorithm 420, a template hashing algorithm 500, a database 600, a template matcher 900, and a hash comparator 1000, a secret unlocking algorithm 110, and a decryption algorithm 1200. In one embodiment, the components include a computer-readable medium containing instructions for performing the steps of the algorithms in accordance with the invention. The system also includes one or more processors for executing the instructions.

The first step in the process is to enroll users into the system such that their biometric template or templates 240 are stored in a database. As with all biometric systems, this is performed by sensing biometric data using the sensor 100, such as a finger swipe or placement sensor. Typically raw data 150 is processed to reduce it to a biometric template 220 that is in an appropriate format for later matching. The template is stored in the database 600 along with a unique identifier of the template, called the hash 550. The hash can be a cryptographic hash such as MD-5 or SHA-1, or it can be a simple checksum or other algorithm that produces a fairly unique value from the sensed input data. The hash is stored along with the template in the database 600 for later use.

In some embodiments, the sensor 100 is a non-biometric device such as a user input device. For example, if the sensor is a keyboard, then the output is a password.

Once a user is enrolled, it is possible to lock (e.g., encrypt) an arbitrary secret in accordance with the invention. A new encryption key 410, such as a 256-bit Advanced Encryption Standard (“AES”) key, is generated using a random number generator 400 or any other means available on the computing platform. The secret data 300 is then encrypted using a standard encryption algorithm 420 using the generated key. The resulting output is a string of random bytes (ciphertext). Any encryption algorithm can be used, such as Data Encryption Standard (“DES”), AES, Blowfish or other algorithms known to those skilled in the art. In a preferred embodiment, if the size (number of bytes) in the encrypted secret is below a threshold, random data is appended to it to increase the size. This “padding” is able to be used in the next step (key “embedding” or “hiding”) so that it is mathematically harder to locate the key within the ciphertext.

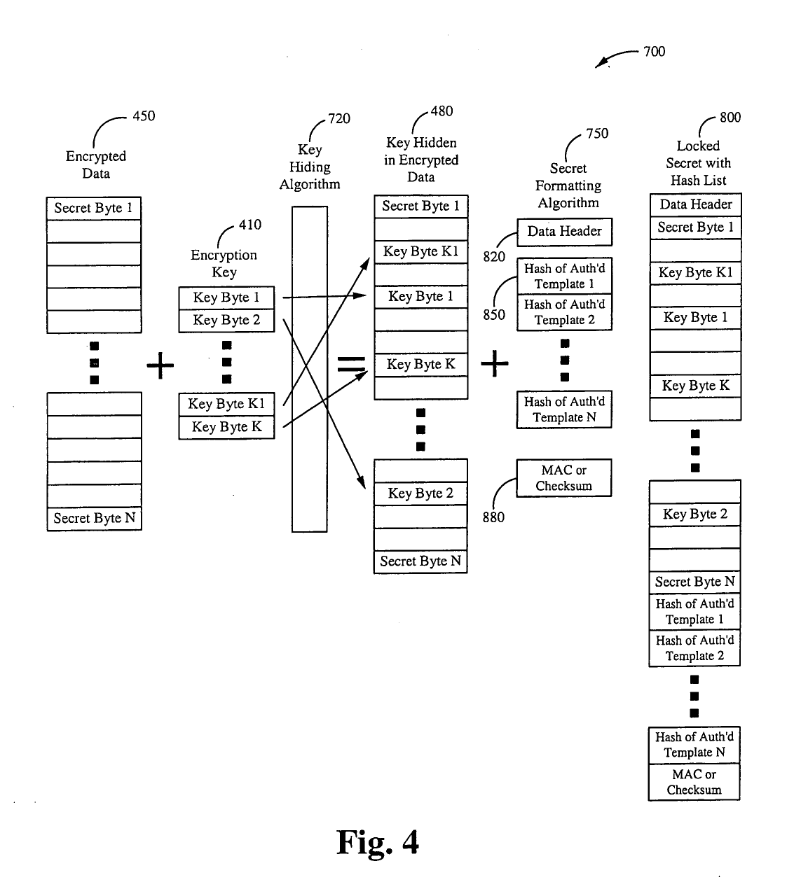

The next step is to hide the encryption key itself or a derived version of it (e.g., “key data,” such as an encrypted key) within the ciphertext. This is advantageous because it allows the invention to use self-contained secrets, each of which can have its own decryption key and has no reliance on the peculiarities of a platform's file system. Referring to FIG. 4, the secret locking process 700 works as follows. The individual bytes of the encryption key 410 are inserted into the encrypted data 450 byte-by-byte in an order (also referred to as an “embedding sequence”) unknown to an attacker. This scrambling process is performed by the key hiding algorithm 720. The result is a set of random bytes 480 containing the encrypted data plus the scrambled key. In alternative embodiments, the actual bytes are inserted using a mathematically reversible function of the key itself, such as symmetric encryption. In yet another alternative embodiment, individual bits instead of bytes of the key are scrambled. Other options known to those skilled in the art for scrambling and inserting the key, especially other steganographic methods, can be used as well.

Preferably, once the key is embedded, some formatting 750 is done to ensure that the secret can be unlocked only with an authorized biometric authentication. One step in the formatting process is to add a plaintext header to the data for computing purposes. The header is able to contain meta information about the secret which is not, in itself, private, and makes the unlocking process easier. One example of meta information is an indicator of whether a backup password was supplied to unlock the data. In that way, it can be determined whether the last hash value in the authorized list is from a password and not a template. In alternative embodiments no such header is used. The next step is to append the authorized template list 850 to the data. The list simply contains the hash values of the enrolled templates A and B authorized to unlock the secret, and no others. The hash values of enrolled templates A and B are appended to the list. In this way, different people or different parts of those people (e.g., index finger and/or thumb print) are authorized to unlock the secret.

Finally, to ensure authenticity such as by detecting tampering, a Message Authentication Code (MAC) 880 is computed for the formatted data, which is essentially a cryptographic hashing algorithm such as UMAC, HMAC, Poly 1305-AES, or any other algorithm known to those skilled in the art. In alternative embodiments, the MAC is computed on the plaintext data first, or it is omitted entirely. The formatting algorithm 750 combines the data header 820 plus the authorized hash list 850 plus the MAC 880 with the encrypted data and scrambled key 480 to form the self-contained locked secret 800. In an alternative embodiment, the plaintext secret 300 is combined with the authorized hash list 850 and the MAC and then encrypted. Once encrypted, the key 410 is able to be inserted using the key hiding algorithm 720. This is more secure as it prevents the authorized list from being tampered with. In yet another embodiment, no MAC is used at all, in which case authenticity of the locked secret cannot be verified.

This locked secret is then able to be saved to the file system or database 600 in plain sight. The locked secret is also able to be moved to other file systems, or stored on a network server or a smartcard and used on other platforms that execute the invention.

In an alternative embodiment, the user provides a backup password that can also be used to unlock the secret in case the biometric authentication fails for any reason. In this case, the hash of the password is saved in the authorized hash list 850 as if it were just another template hash.

While FIG. 4 shows only a single template hash, it will be appreciated that an arbitrarily long list of template hashes can be used.

Once the secret has been successfully locked, it will presumably need to be unlocked later when the user or users require access to it. Again referring to FIG. 3, the unlocking process begins with a user scanning his or her biometric using the sensor 100. As during the biometric enrollment process, raw data 150 is processed into a live-scan biometric template 220 for authentication. The template matcher 900 compares the live-scan template 910 to one or more of the previously enrolled templates 240. If the biometric match is not successful, the process stops and the secret remains locked. If the match is successful, the hash of the enrolled template 550 is bit-by-bit compared 1000 to each hash in the authorized hash list 850 of the locked secret 800. If there is no matching hash in the list, the secret remains locked.

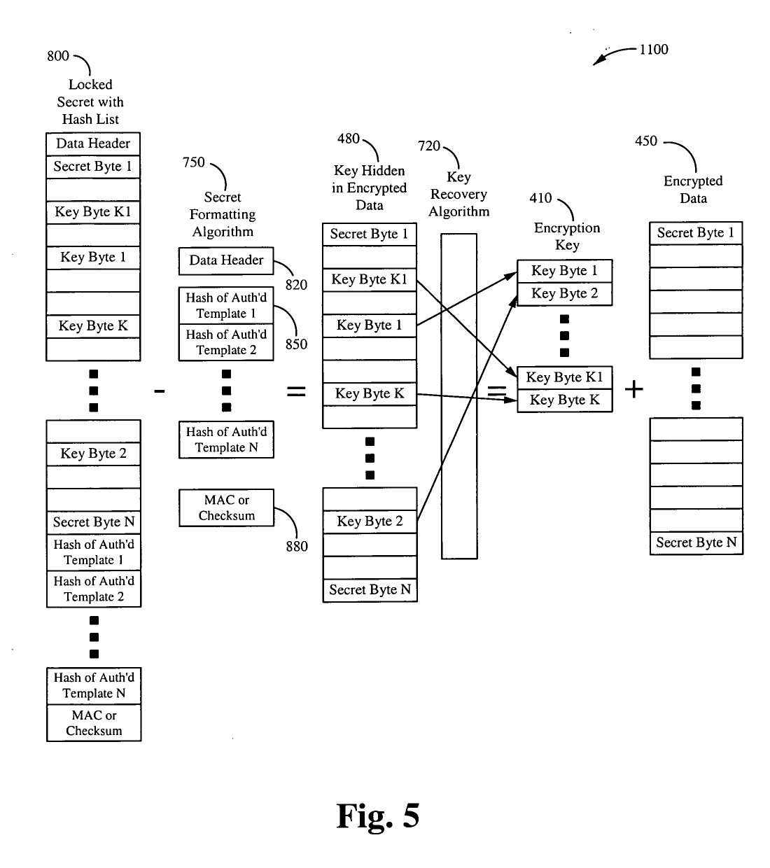

Referring to FIGS. 3 and 5, if one or more entries in the list 850 are found to be identical 1010 to the hash of the enrolled template, then the secret unlocking algorithm 1100 is employed to reverse the locking process. First, the key 410 is extracted using the key recovery algorithm 1150 and used to decrypt the secret. The authorized user list 850 and header 820 are stripped away and the original plaintext secret 300 remains. At this point the MAC can be used to ensure that the secret data was not tampered with. If it was tampered with, the secret, if decrypted, is destroyed and the secret is not returned to the requester. If it was not tampered with, the secret is returned to the requester to use as needed.

Key data are able to be embedded or hidden within ciphertext according to many different types of key hiding algorithms. FIGS. 6A-C show ciphertext with key data embedded at different locations in accordance with the present invention. FIG. 6A shows ciphertext 1200 with key data segments K1-K4 embedded at regularly spaced intervals. FIG. 6B shows ciphertext 1210 with key data segments K1-K4 embedded at intervals spaced by increasingly larger values, such as by an arithmetic or geometric sequence. FIG. 6C shows ciphertext 1220 with key data segments K1-K4 embedded at random sequences and randomly spaced intervals. As one example, the hiding algorithm generates offsets to store key segments using a random or pseudo-random number generator. Other algorithms can be used, so long as they are reversible, that is, able to remember or regenerate the offsets to recover and combine the key segments. Those skilled in the art will recognize other ways of embedding key data segments within ciphertext so that they can be later recovered, combined, and if necessary, decrypted, to recover an encryption key.

In accordance with the present invention, key data are able to be segmented in blocks of different sizes. Again referring to FIG. 1, the key segments 20A-E are formed by allocating portions or blocks of the key among the segments 20A-E. In one embodiment, the key is segmented by allocating the first 10 bits of the key 20 to the segment or block 20A, the next 10 bits of the key 20 to the segment 20B, the next ten bits of the key 20 to the segment 20C, etc. In this embodiment, the segments are all equal sized. In another embodiment, the key 20 is segmented by allocating the first 10 bits to the segment 20A, the next 20 bits to the segment 20B, the next 30 bits the segment 20C, etc., such that each segment contains 10 more bits that the previous segment. In this embodiment, the segment sizes have an arithmetic progression. In still other embodiments, the key 20 is segmented by allocating the first 2 bits to the segment 20A, the next 4 bits to the segment 20C, the next 32 bits to the segment 20B, etc. Those skilled in the art will recognize many different ways to allocate bits-both in size and location.

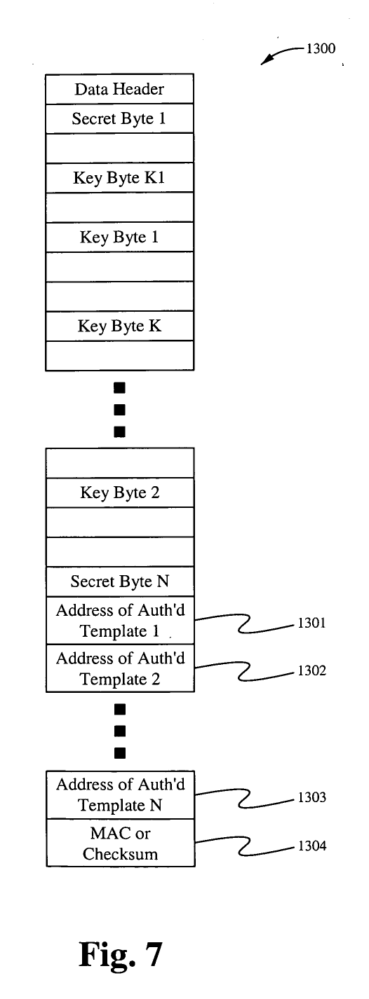

While FIG. 4 shows hashes of authorized templates appended to a locked secret, it will be appreciated that other identifiers for hashes are able to be appended to a locked secret. One example, shown in FIG. 7, shows addresses of hashes appended to the locked secret. Using this embodiment, the address is used to retrieve one or more hashes or one or more templates, which are able to be stored on and retrieved from remote storage devices.

It will be appreciated that templates, hashes, and other data can be appended indirectly to ciphertext in accordance with the present invention. In other words, intervening information can be placed between ciphertext and its appended hash or template.

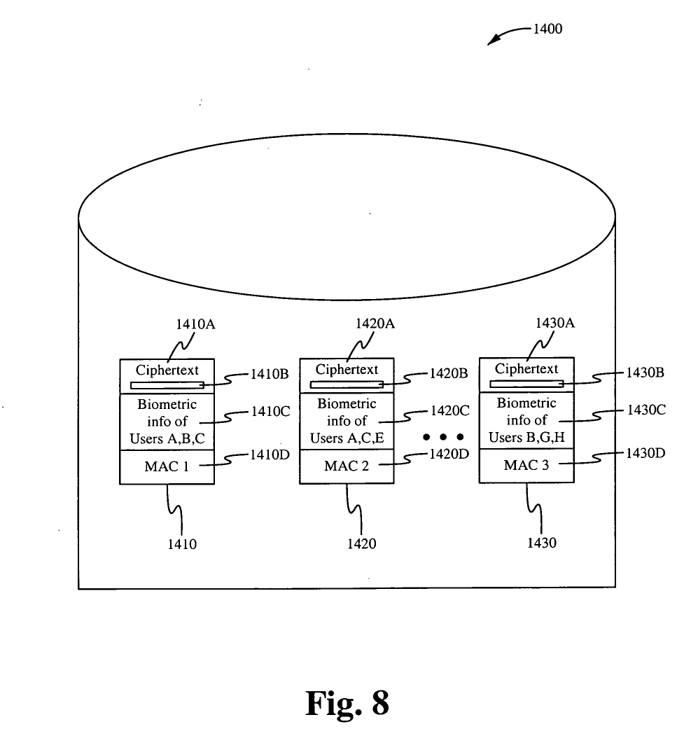

FIG. 8 illustrates a file system 1400 containing multiple locked secrets in accordance with the present invention. In one embodiment, the file system 1400 is used in conjunction with the algorithms and data structures illustrated in FIG. 3. The file system 1400 contains data modules 1410, 1420, and 1430. Each data module has a block of ciphertext with key data distributed throughout, biometric information identifying users who have permission to decrypt the ciphertext, and a MAC block. The exemplary data module 1410 contains ciphertext 1410A with distributed key data 1410B, biometric information 1410C, and a MAC block 1410D. The biometric information 1410C includes hashes of templates of fingerprint images for users A, B, and C, all of whom have permission to decrypt the ciphertext 1410A.

Preferably, each of the keys 1410B, 1420B, and 1430B is different from the others. In alternative embodiments, for each pair of modules 1410, 1420, and 1430, (1) both the key and the hiding algorithm are different, (2) only the combinations of key and hiding algorithm are different (e.g., if two modules share the same key, then their hiding algorithms are different and vice versa), and (3) both the key and the hiding algorithm are the same. Those skilled in the art will recognize other combinations of keys and hiding algorithms across different locked data modules on a file system.

For ease of illustration, FIG. 8 shows the keys 1410B, 1420B, and 1430B as single blocks. It will be appreciated that keys 1410B, 1420B, and 1430B are preferably segmented, distributed throughout the ciphertext 1410A, 1420A, and 1430A, respectively.

Preferably, the locations of the segments are determined by the identities of the keys themselves. As one example, the identity of the key 1410B determines that its segmented blocks are distributed at the locations L1, L2, L3 . . . LN (not shown) within the ciphertext 1410A; and the identity of the key 1420B determines that its segmented blocks are distributed at the locations R1, R2, R3 . . . RX (also not shown, and different from L1-LN) within the ciphertext 1420A.

In one embodiment, a hash of a key is used as an index to a table of key hiding algorithms. In this way, an identity (or other characteristic) of a key determines the key-hiding algorithm and thus the locations of the embedded key data segments. Those skilled in the art will recognize other ways in which a key, key data, or any other characteristic of a key determines how segments of key data are distributed throughout ciphertext in accordance with the present invention.

In one embodiment, encrypting plain text begins with generating a MAC or checksum for the plain text. Next, an encryption key is used to encrypt the plain text to produce ciphertext. For added security, the encryption key is itself encrypted using a fixed key hidden in the executable code, to generate key data, which is then segmented and interspersed within the ciphertext at predetermined locations. Biometric information of authorized users is also encrypted and then appended, with a MAC or checksum of the plain text, to the ciphertext package. The “locked” secret is now able to be unlocked on the file system on which it was locked or transported to another (e.g., target) file system and unlocked there.

When the secret is to be unlocked, a user's biometric information is obtained, such as by using a fingerprint sensor. If the biometric information matches information of enrolled users, a hash of the biometric information is used to determine whether the user has authorization to unlock the secret by decrypting the ciphertext to obtain the plain text. If the user does have authorization, then the key data is extracted, combined (e.g., concatenated), and then decrypted to recover the key. (The key recovery program and the decryption algorithm are both stored on the target file system.) Using the key, the encrypted biometric information of authorized users is used to determine whether the user has permission to decrypt the ciphertext. If the user does have permission, the key is now used to decrypt the ciphertext to recover the plain text. The MAC or checksum is then used to determine whether the secret has been tampered with. If the secret has not been tampered with, it is returned to the user.

In another embodiment, the enrolled templates used to determine whether a biometric match exists are also encrypted. In this case, the template must be decrypted before it can be used in a match. The template does not have a list of users authorized to decrypt it, because it must be decrypted before it can be used in the matching process. The authorized list would therefore be NULL; that is, anyone can decrypt it.

It will be appreciated that while the examples above describe fingerprint images as the biometric data, other biometric data such as palm prints and retinal images can also be used in accordance with the present invention. Any data structure can be used as a key, so long as it able to be used to lock and reversibly unlock a secret in accordance with the present invention. In all the methods described above, some steps can be deleted, others can be added, and all can be performed in different orders. For example, a MAC or checksum can be generated for any combination of ciphertext, biometric data, and headers.

It will be readily apparent to one skilled in the art that other modifications may be made to the embodiments without departing from the spirit and scope of the invention as defined by the appended claims.

I claim:

1. A method of formatting ciphertext comprising:
encrypting clear data with a key to thereby produce ciphertext;
embedding blocks of key data corresponding to the key at multiple predetermined locations within the ciphertext; and
associating biometric information with the ciphertext, wherein the biometric information corresponds to one or more users authorized to decrypt the ciphertext.

2. The method of claim 1, wherein associating biometric information with the ciphertext comprises appending the biometric information to the ciphertext.

3. The method of claim 1, wherein associating biometric information with the ciphertext comprises appending an identifier of the biometric information to the ciphertext.

4. The method of claim 3, wherein the identifier of the biometric information comprises an address of the biometric information.

5. The method of claim 1, wherein the biometric information is encrypted using the key before the biometric information is associated with the ciphertext.

6. The method of claim 1, further comprising encrypting the key to generate the key data.

7. The method of claim 1, wherein the biometric information comprises one or more hashes of biometric templates.

8. The method of claim 7, wherein the biometric templates are templates of fingerprint images.

9. The method of claim 8, wherein each of the one or more hashes is generated using one of MD-5, Secure Hash Algorithm-1, and a checksum.

10. The method of claim 1, wherein the key is generated using any one of Data Encryption Standard, Advanced Encryption Standard, and Blowfish.

11. The method of claim 1, wherein encrypting clear data comprises appending pad bits to the ciphertext if a length of the ciphertext is less than a predetermined threshold value.

12. The method of claim 1, wherein each of the blocks is a multiple of one byte long.

13. The method of claim 1, wherein each of the blocks is 1 bit long.

14. The method of claim 1, further comprising appending an authentication code for the ciphertext to the ciphertext.

15. The method of claim 14, wherein the authentication code is a message authentication code.

16. The method of claim 15, wherein the message authentication code is a cryptographic hashing algorithm selected from the group consisting of Universal Hashing Message Authentication Code (UMAC), Hash Message Authentication Code (HMAC), and Poly 1305-AES.

17. The method of claim 1, wherein a predetermined locations are dependent on an identity of the key.

18. The method of claim 1, further comprising encrypting one or more biometric templates associated with users authorized to access ciphertext on a file system and appending the encrypted one or more biometric templates to the ciphertext.

19. A method of recovering plain text from ciphertext comprising:
successfully matching first biometric information to second biometric information, wherein the second biometric information is associated with a user authorized to recover the plain text;
combining segments of key data embedded throughout the ciphertext to thereby retrieve a decryption key; and
using the decryption key to decrypt the ciphertext to thereby recover the plain text.

20. The method of claim 19, wherein the first biometric information and the second biometric information are both hashes of biometric templates.

21. The method of claim 20, wherein the biometric templates are templates of fingerprint images.

22. The method of claim 19, wherein combining segments of key data comprises appending the segments and filtering the appended segments to retrieve the encryption key.

23. The method of claim 22, wherein the appended segments form encrypted key data and filtering comprises decrypting the appended segments.

24. The method of claim 19, further comprising comparing a characteristic of the recovered plain text with a corresponding characteristic stored for the recovered plain text to thereby ensure that the plain text has not been tampered with.

25. The method of claim 24, wherein the unique characteristic is generated by performing a hashing algorithm on the recovered ciphertext.

26. A data storage system comprising:
a plurality of data blocks, each data block comprising:
ciphertext containing segmented key data derived from a key used to encrypt it embedded throughout; and
template information identifying one or more users authorized to decrypt the ciphertext to recover corresponding plain text.

27. The data storage system of claim 26, wherein for each data block, the template information is appended to the ciphertext.

28. The data storage system of claim 26, wherein the key data for the plurality of data blocks are different from one another.

29. The data storage system of claim 26, wherein the template information for each of the data blocks is a fingerprint template.

30. The data storage system of claim 26, further comprising a computer-readable medium containing computer-executable instructions for performing a method comprising:
encrypting plain text to generate ciphertext;
generating key data from a key;
embedding segments of the key data at predetermined locations within ciphertext; and
associating first biometric information with the ciphertext containing the embedded segments of the key data.

31. The data storage system of claim 30, wherein the method further comprises:
successfully matching second biometric information with the first biometric information;
retrieving the embedded key data from the ciphertext;
recovering the key from the key data; and
using the key to decrypt the ciphertext to thereby recover the plain text.

32. The data storage system of claim 31, wherein recovering the key from the key data comprises combining segments of the key data.

33. The data storage system of claim 32, wherein recovering the key from the key data further comprises decrypting the key data.

34. The data storage system of claim 31, wherein the method further comprises verifying that the ciphertext has not been tampered with.
